(19) United States
(12) Patent Application Publication
(10) Pub. No.: US 2010/0012696 A1
(43) Pub. Date: Jan. 21, 2010

(54) BICYCLE ARTICLE CARRIER

(76) Inventor: Thomas Ferdinand Prager, Huntington Beach, CA (US)

Correspondence Address: OC PATENT, P.C;ATTN: MATT MUSHET, ESQ, 6332 ROYAL GROVE, HUNTINGTON BEACH, CA, 92648, US

(21) Appl. No.: 12/421,265

(22) Filed: Apr. 9, 2009

Related U.S. Application Data
(60) Provisional application No. 61/082,144, filed on Jul. 18, 2008.
(60) Provisional application No. 61/156,616, filed on Mar. 2, 2009.

(51) Int. Cl. B62J 9/00

(52) U.S. Cl. 224/417; 224/421; 224/439; 224/463

(57) ABSTRACT

The presently disclosed article carrier for bicycles is adapted for the mid-frame area of a variety of bicycle frame types having improved practical characteristics for conveying a variety of articles while having minimal adverse effects on, a bicycle's handling. The carrier may be quickly installed and, removed without the use of tools or brackets by buckling a pair of fastening assemblies between the handlebar stem and seat-post, components common to a majority of bicycle frame types currently in the marketplace. The carrier offers improved accessibility to its cargo both while riding and while stationary due to its positioning on the bicycle and to particular zipper styles. The carrier is also proportioned and adapted to real-world applications with minimal nuisance and optimal utility due to its means of attachment, its volumetric expandability, its various utilitarian pockets and compartments and its adjustability. A planned line of optional accessories are separably connectable to the article carrier by means of a proprietary “click” clip system for which the article carrier is pre-equipped to accept. The carrier along with its cargo and extended line of optional accessories adapts, to being securely locked to an unattended bicycle. Moreover at the user's discretion, the carrier adapts to being borne by its human user either by its integrated handle or over the shoulder by its integrated shoulder strap with due respect paid to both practical and aesthetic considerations.

### CROSS REFERENCE TO RELATED APPLICATIONS

This application is related to and claims the benefit of 35 U.S.C. §111(b) and the filing dates of provisional application 61/082,144 entitled MIDFRAME BICYCLE ARTICLE CARRIER filed Jul. 18, 2008 and provisional application 61/156,616, entitled IMPROVED BICYCLE ARTICLE CARRIER filed Mar. 2, 2009.

### TECHNICAL FIELD OF THE INVENTION

The invention pertains to article carriers, and more particularly to article carriers for bicycles adapted between the steering headset and the seat-post.

### BACKGROUND OF THE INVENTION

A wide variety of article carriers, or packs, are known for use with bicycles. The more popularly accepted types of bicycle article carriers are typically adapted to be mounted either forward of the handlebars or rearward of the seat. In spite of their apparent popularity, most of these styles pose serious drawbacks for practical use, either by adversely affecting the riding dynamics of the bicycle, by their means of fixed mechanical attachment, by their limited accessibility, or by a combination of these three drawbacks. Forward or rearward positioning can adversely affect steering, weight distribution and center of gravity of the bicycle, possibly causing an adverse effect on the bicycle rider's balance and making the bicycle difficult to steer. Most of the known forwardly-adapted or rearwardly-adapted article carriers are mounted to the bicycle by means of hard, mechanical attachment using mounting brackets and therefore require serious assembly and the use of tools. Further, such mechanical assembly offers the user little choice over what to do with the carrier or its cargo upon arriving at a destination, far from requisite tools. Also such forward or rearward positioning can reduce the cyclist's visual cognizance of and ease of access to the pack and its cargo while riding.

For years, the touring cyclist has had to overcome the drag of peddling a loaded touring bike into a headwind with rectangular touring packs creating unnecessary high wind drag. An example of such packs can be found in U.S. Pat. No. 3,786,972, issued Jan. 22, 1974, to H. R. Alley. Other article carriers are known to have been adapted for the mid portion of the bicycle frame, specifically hanging underneath the horizontal frame. An example of such an article carrier can be found dating as early as the late Nineteenth Century in U.S. Pat. No. 444,642, issued Jan. 13, 1891, to T. G. Allen, Jr., W. L. Sachtleben and J. F. Walters. A more recent example can be found in U.S. Pat. No. 5,249,721, issued Oct. 5, 1993, to William P. Brooks. While volumetric capacity of any mid-frame pack may be substantially less than Alley's voluminous rearward-mounted pannier, prior art of mid-frame article carriers has not yet reached full potential and invites potential optimization.

Although not having gained wide public acceptance, the mid-frame adaptation offers distinct advantages over the more widely accepted forwardly-adapted or rearwardly-adapted bicycle packs. One such advantage is favorable weight distribution. The mid-frame positioning of the added mass does not significantly alter the bicycle's center of gravity and does not interfere with bicycle steering. The mid-frame adaptation also offers advantageous ergonomic accessibility, positioning the pack's zippered compartments and cargo within easy reach and sight of the bicycle rider. Moreover, the entire pack and its cargo may be cradled within and therefore protected by the cyclist's knees and legs, in the event of a spill or undue vibrations caused by road conditions. This intimate and immediate personal contact may well prove critical when considering the cargo may be as valuable and irreplaceable as a college student's laptop computer and loose-leaf notebooks, or as fragile as a grocery shopper's dozen eggs.

Why then has the mid-frame adaptation been largely overlooked? Typically, prior art of such mid-frame article carriers have been dependent on a particularly shaped bicycle frame of fixed size, that being the conventional “men's” bicycle frame, composed of a horizontal top tube, a vertical seat tube, a short vertical fork tube, and a long diagonal tube extending between the fork tube and the seat tube, resulting in a triangular void defined within the bounds of the frame. While generally of similar convention, specific dimensions and geometries of differing models of such frames differ subtly but significantly from model to model. Prior art must typically conform to a particular dimension and geometry of a certain “men's” bicycle frame in question, and none other. Moreover, these known mid-frame article carriers have generally relied on being hung by gravity beneath the horizontal top tube by means of attachment straps or the like. Additional fastening straps have typically been positioned on additional frame members created by the conventional “men's” bicycle frame, often resulting in an inordinate number of fastening points for the user to attach, and requiring undesirable squatting or kneeling bodily positions in close proximity to the ground and the greasy chain in order to assemble and disassemble the pack to the bicycle. Many such mid-frame packs are also rendered obsolete in today's marketplace, as the conventional, triangular “men's” bicycle frame is recently giving way to a plethora of unconventional frame designs not necessarily featuring the traditional requisite horizontal top tube arrangement. Further, even in those frames still featuring a horizontal top tube, today's manufacturers often route derailleur and brake cabling on the upper apex or side of the horizontal top tube rather than routing this cabling underneath the top tube as typical in the past, thus interfering and being interfered with the prior art's gravity-hung attachment mechanism. Additionally, the prior art's scope has typically been compromised in terms of volumetric capacity, having been designed to carry only very thin objects of a substantially limited size and nature. Finally, securely locking the article carrier and its cargo has typically been ignored in prior art.

The present disclosure overcomes these disadvantages by providing superior aerodynamic streamlining compared to such forward-mounted or rearward-mounted bicycle packs. The present disclosure's unique straps are designed to more easily attach to any size or style of bike. It also overcomes the mid-frame prior art by changing the size from a thin static envelope to a dynamically mounted, larger capacity and appropriately shaped pack, through the use of special zippers, adjustment cords and expansion gussets. These openings in the improved article carrier not only allow for increased accessibility while riding but also for simple attachment and removal from the bike which aids in both portability and security.

Throughout the foregoing disclosure and design, considerable attention has been paid to make the present disclosure suit the needs of the bicycle-using public.

### SUMMARY OF THE INVENTION

The present disclosure provides for an article carrier which is uniquely easy to attach and remove from a wide variety of bicycles without using brackets and without the use of tools. It uniquely depends on support from two components known to be common to the majority of bicycles, those being the handlebar stem including its associated headset and the seat including its associated seat-post clamp, and possibly their associated protruding locknuts. The preferred embodiment of the disclosure utilizes expansion gusset panels, which maximize potential capacity while minimizing potential nuisance and resistance. The disclosure also comprises adjustment cords in one embodiment. Once arrived at a destination and detached from the bicycle, the article carrier is conveniently adapted to being carried either by hand or over the shoulder. Alternatively, according to the user's discretion, the article carrier and its cargo may be securely locked along with the bicycle to which it is attached using a standard commercially available bicycle cable and padlock; further, it is equipped with proprietary means of independently fastening any of a line of theft-proof optional accessory items such as lights, gadget holders and the like.

Thus, the disclosed article carrier provides an apparatus for transporting users' items such that they are protected from temperature changes, moisture levels, physical impacts and vibrations. The article carrier is aerodynamic, appropriately shaped and has a well-distributed center of gravity that does not adversely affect the steering or operation of the bicycle. While riding, parked or carried, the article carrier presents itself, its accessories and its cargo within easy reach and sight of the user.

These and other aspects, objects and features of the invention will be more fully appreciated and understood by reference to the drawings and detailed description of those drawings.

### BRIEF DESCRIPTION OF THE DRAWINGS

FIGS. 1A-D show silhouette elevation views of four typical configurations of fragmentary bicycle frame types currently popular in today's marketplace.

FIG. 2 shows an elevation view of the preferred embodiment of an article carrier according to the present disclosure mounted to a fragmentary bicycle.

FIG. 3A shows a top view of the preferred embodiment of an article carrier according to the present disclosure with reference to its attachment to one of a variety of bicycle frame types by means of ratchet buckles and ladder straps.

FIG. 3B shows a detailed perspective view seen from above the right front corner of a fragmentary article carrier with reference to the manner in which the ratchet buckles and ladder straps attach the article carrier to the bicycle using a protrusion of the bicycle itself.

FIG. 3C shows a detailed perspective view seen from above the right front corner of a fragmentary article carrier with reference to the manner in which the ratchet buckles and ladder straps attach the article carrier to the bicycle using an externally supplied protrusion.

FIGS. 4A-E show a top view of the preferred chronological sequence of events employed to buckle and unbuckle the ladder straps to and from the associated ratchet buckles of a fragmentary article carrier according to the preferred embodiment of the present disclosure.

FIGS. 5A-C show an elevation view of the preferred chronological sequence of events employed to attach an article carrier according to the preferred embodiment of the present disclosure to a fragmentary bicycle by a human person.

FIG. 5D shows an elevation view, from the reverse side of FIG. 2, of the preferred embodiment of an article carrier according to the present disclosure mounted to a fragmentary bicycle.

FIG. 6A shows a plan view of the: outer surfaces of an unfolded article carrier according to the preferred embodiment of the present disclosure.

FIG. 6B shows a plan view of the underside surfaces of an unfolded article carrier according to the preferred embodiment of the present disclosure. (Dashed lines indicate adjustment cord mechanisms otherwise hidden in underside pockets.)

FIG. 6C shows a detailed view of a corner attachment flap of a saddlebag of FIG. 6B, with a pair of fragmentary ladder straps passing through a slit, demarked by small black squares at the stitches' endpoints, and the possible pivotal arc allowed by this gap in the corner attachment flap's stitching.

FIG. 7A shows a perspective view taken from the left rear of an article carrier according to the present disclosure mounted to a fragmentary bicycle with its bottom tether unfastened.

FIG. 7B shows a detailed view of FIG. 7A with the article carrier's bottom tether in its fastened mode.

FIG. 8 shows a top view of an article carrier according to the disclosure with both saddlebags unzipped to reveal those saddlebags' inner zippered or mesh pockets.

FIG. 9A shows a perspective view taken from the right front of an article carrier according to the disclosure, with an unzipped right zippered saddlebag revealing an inner compartment.

FIG. 9B shows a detailed view of FIG. 9A showing two repositionable laptop compartment dividers.

FIG. 10A shows a top view of an article carrier according to the disclosure in an expanded condition, mounted to a fragmentary bicycle, moreover showing a fragmentary rider's hands, knees and upper legs from the same view in reference to the possible clearance tolerances.

FIG. 10B shows an exploded top view of an expansion gusset pattern of the preferred embodiment including two mirror-image pattern parts, with forward being up and rearward being down.

FIG. 10C shows a top plan view of the expansion gusset pattern of FIG. 10B after having been sewn together to make one pleated expansion gusset with concentric lines indicating increasing topographic depth, again with forward being up and rearward being down.

FIG. 10D shows a perspective view of the expansion gusset of FIG. 10C, with forward being right and rearward being left.

FIG. 11A shows a cross-sectional rear view of an article carrier according to the preferred embodiment of the present disclosure through its widest point in an unexpanded condition.

FIG. 11B shows a cross-sectional rear view of an article carrier according to the disclosure through its widest point in an expanded condition, mounted to a fragmentary bicycle, moreover showing a bicycle rider's foot and ankle from the same view in reference to the possible clearance tolerances.

FIG. 12A shows a simplified elevation view of the underside profile of the left saddlebag of an article carrier according to the disclosure, including adjustment cords in unadjusted mode.

FIG. 12B shows a cross-sectional detail of FIG. 12A, showing fragmentary adjustment cords and the upper one-way cordlock of the pair of associated one-way cordlocks of FIG. 12A, with a brake wheel in unbraked mode, including double-headed arrows to indicate free movement of the fragmentary cords through the one-way cordlock in either direction.

FIG. 13A shows a simplified elevation view of the underside profile of the left saddlebag of an article carrier according to the disclosure, including adjustment cords in adjusted mode, with radiating lines indicating wrinkling to the saddlebag fabric under stress resulting from the adjustment. Moreover, a second profile of FIG. 12A is superimposed (in phantom lines) indicating the difference in profile between adjusted and unadjusted modes for comparison.

FIG. 13B shows a cross-sectional detail of FIG. 13A, showing fragmentary adjustment cords and the upper one-way cordlock of the pair of associated one-way cordlocks of FIG. 13A with its brake wheel in braked mode, with outwardly and upwardly pointing arrows to indicate movement of the fragmentary cords is prevented or stopped through the one-way cordlock in that direction. Additional larger outlined arrows outwardly and then inwardly turning around bicycle frame members (in phantom lines) are shown to represent the directional tug of unseen ratchet assemblies.

FIG. 14A shows a top view of the preferred embodiment of an article carrier according to the present disclosure mounted to a fragmentary bicycle in a securely locked mode.

FIG. 14B shows a detail view of an article carrier's four compartment door zipper pull-tabs aligned to accept a fragmentary shackle of a padlock.

FIG. 15 shows a perspective view taken from the right front an article carrier according to the disclosure with a shoulder strap draped over the outside of the right saddlebag.

FIG. 16 shows a plan view of the underside surfaces of an unfolded article carrier according to the disclosure with a shoulder strap shown partially in phantom lines where it is partially hidden in an underside pocket of the left saddlebag.

FIG. 17 shows a perspective view from the right front of a fragmentary human person bearing an article carrier according to the disclosure by its shoulder strap in an over-the-shoulder carrying mode.

FIG. 18 shows an elevation view a fragmentary human hand holding an article carrier according to the preferred embodiment of the disclosure by an integrated carrying handle.

### DETAILED DESCRIPTION OF THE PREFERRED EMBODIMENT

1. Attachment to a Bicycle

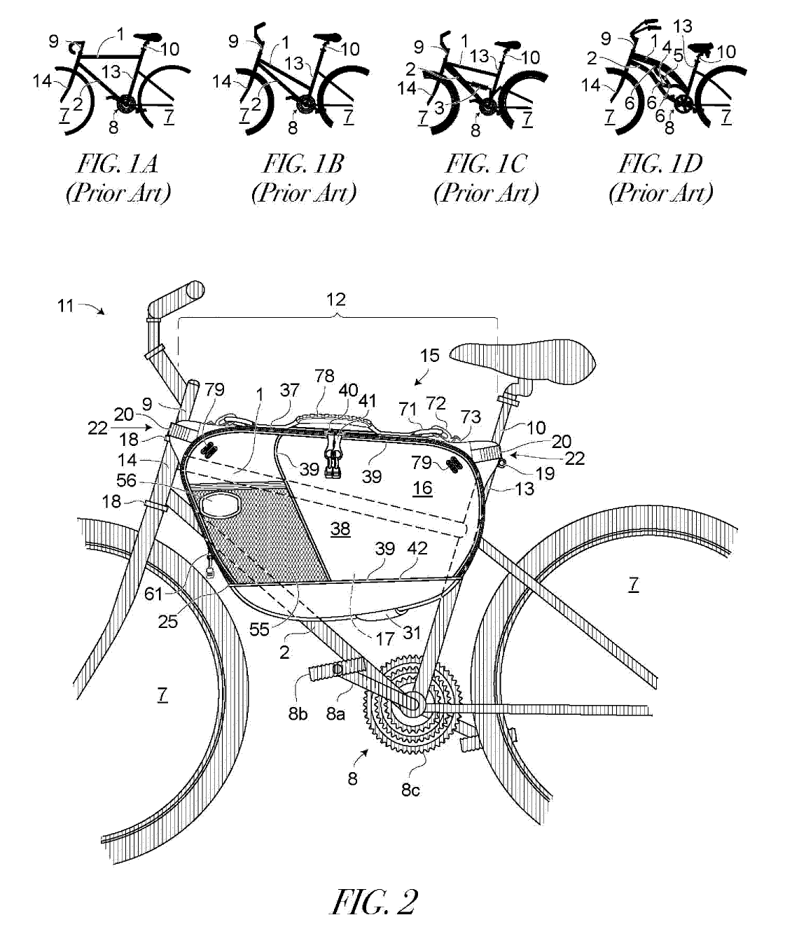

With reference to FIGS. 1A-D, those skilled in the art will recognize from the prior art that: FIG. 1A represents in silhouette a typical “men's” racing-style bicycle frame characterized by a generally horizontal top tube 1; FIG. 1B represents in silhouette a typical “women's” road-style or touring-style bicycle frame characterized by an especially low and downwardly sloping top tube 1; FIG. 1C represents in silhouette a BMX-style or mountain bike-style bicycle frame characterized by a generally downward sloping top tube 1, an especially robust bottom tube 2 and sometimes a rear suspension assembly 3 sometimes occupying the mid-frame void; and that FIG. 1D represents in silhouette a “California Cruiser”-style bicycle frame characterized by a variously stylized curvilinear top tube 1 and a variously stylized curvilinear bottom tube 2, often including similarly variously stylized auxiliary tubes 4 and 5 at various intersection points 6 in a style generally reminiscent of days gone by. Components usually common to all four bicycle frame types are front and rear wheels 7, fork tube 14, seat tube 13 and a crankset 8, and, of particular interest regarding the present disclosure, a handlebar stem 9 including its associated headset and a seat-post 10, both with protruding tightening hardware. Handlebar headsets are also referred to in the art as steering headsets.

With reference to FIG. 2, an elevation view of the preferred embodiment of article carrier 15 according to the present disclosure is shown attached to a representative bicycle. The bicycle style could possibly comprise one of the styles mentioned supra and shown in FIGS. 1A-D. Dashed lines indicate a possibly moderately downward-sloping top tube 1 as a modern variant on the traditional horizontal top tube 1 of FIG. 1A, behind carrier 15's left saddlebag 16 and in front of right saddlebag 17 (shown with dashed lines). Also in this view, tether 31 is shown attaching saddlebags 16, 17 without hooking under any part of the bicycle frame, thus causing saddlebags 16, 17 to draw together, often sandwiching a portion of a frame member. In the preferred embodiment, tether 31 is constructed of an elastic material to tighten saddlebags 16, 17 together, but could also be envisioned to be a fixed length or constructed of an equivalent material. Also, saddlebags may also be defined as simply bags, pockets or compartments.

With reference to FIGS. 2 and 5D, bicycle 11 includes a tubular frame 12 that may or may not have any of a variety of top tubes 1. Attached to the rearward end of any of a variety of top tubes 1 (partially hidden) is a substantially vertical seat tube 13. The forward end of any of a variety of top tubes 1 joins a substantially vertical fork tube 14. Fork tube 14 houses an unseen headset held in position at its upper and lower ends by protruding headset locknut 18. Frame 12 may have any of a variety of downwardly and rearwardly projecting bottom tubes 2 that join the bottom of vertical seat tube 13 and vertical fork tube 14. A crankset 8 comprised of a pair of diametrically opposed cranks 8a on both left and right sides of frame 12, including an associated pair of pedals 8b and an associated set of front chainrings 8c on the right side of frame 12, intersects perpendicularly through the vertices of any of a variety of bottom tubes 2 and seat tube 13. Seat-post 10 fits into seat tube 13 and is adjustably locked into a particular seat height of the rider's discretion by means of seat-post clamp 19. Those skilled in the art will recognize that the actual shape of bicycle frame 12 will depend upon the type and manufacture of the frame. Thus, frame 12 in FIGS. 2 and 5D is merely for illustrative purposes.

Also with reference to FIGS. 2 and 5D, in the preferred embodiment, article carrier 15 conforms generally to the angle of tube 13 at its rear profile, and its upper profile conforms generally parallel to a straight line drawn from the upper lip of headset locknut 18 through the upper lip of seat-post clamp 19. The bottom profile of article carrier 15 conforms generally to the apex of the arc drawn through the sweep of crank pedals 8b. Lower front corner 25 of article carrier 15 may extend nearly as far as front wheel 7, but not so far as to interfere with front wheel 7. Article carrier 15 thus uses a maximum amount of the space available in the mid-frame area of a bicycle, while striking a balance between simple geometric configurations and aesthetic considerations. In an alternate embodiment, article carrier 15 may take other shapes that fit within the mid-frame area of bicycle 11 or comprise sides, corners or edges that slightly extend past frame 12 of bicycle 11.

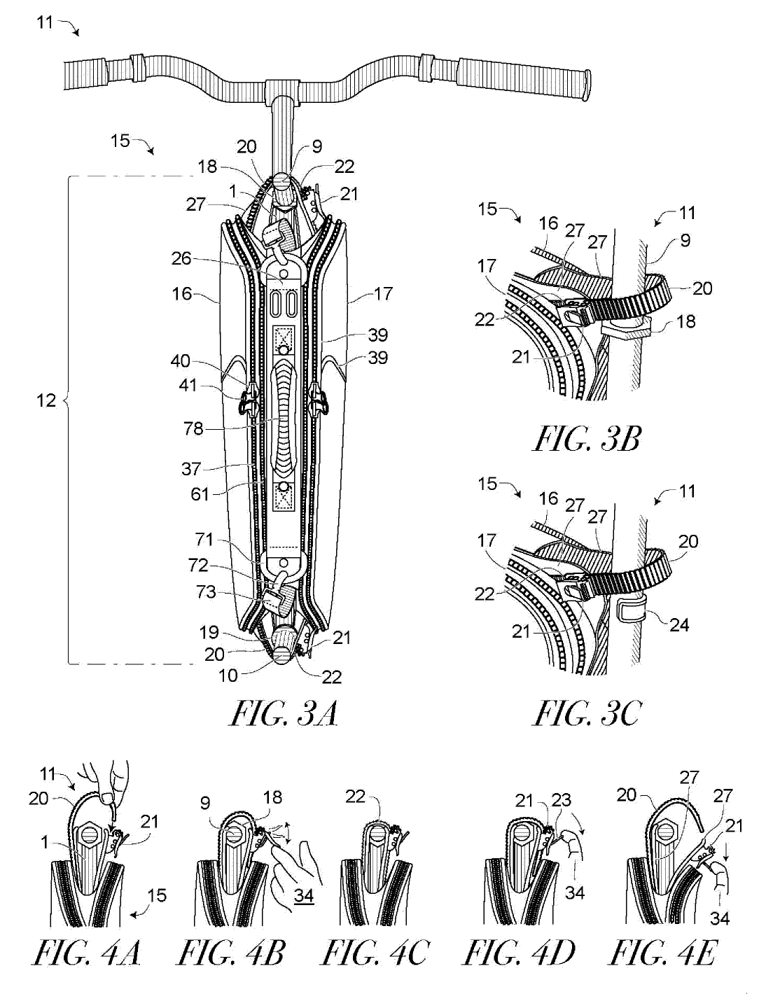

With reference to FIGS. 2, 3A-C, 4A-E, 5D and 7A-B, the preferred embodiment of article carrier 15 is attached to bicycle 11 supported at the front by ratchet strap assembly 22 wrapping handlebar stem 9 while resting atop and being restrained against gravity by protruding headset locknut 18, and at the rear by a second ratchet strap assembly 22 wrapping seat-post 10, riding atop and being restrained against gravity by protruding seat-post clamp 19. In the preferred embodiment, ratchet strap assemblies comprise a quick release buckle and notched straps or ladder straps, but could easily be envisioned to simply comprise any means of attachment known in the art.

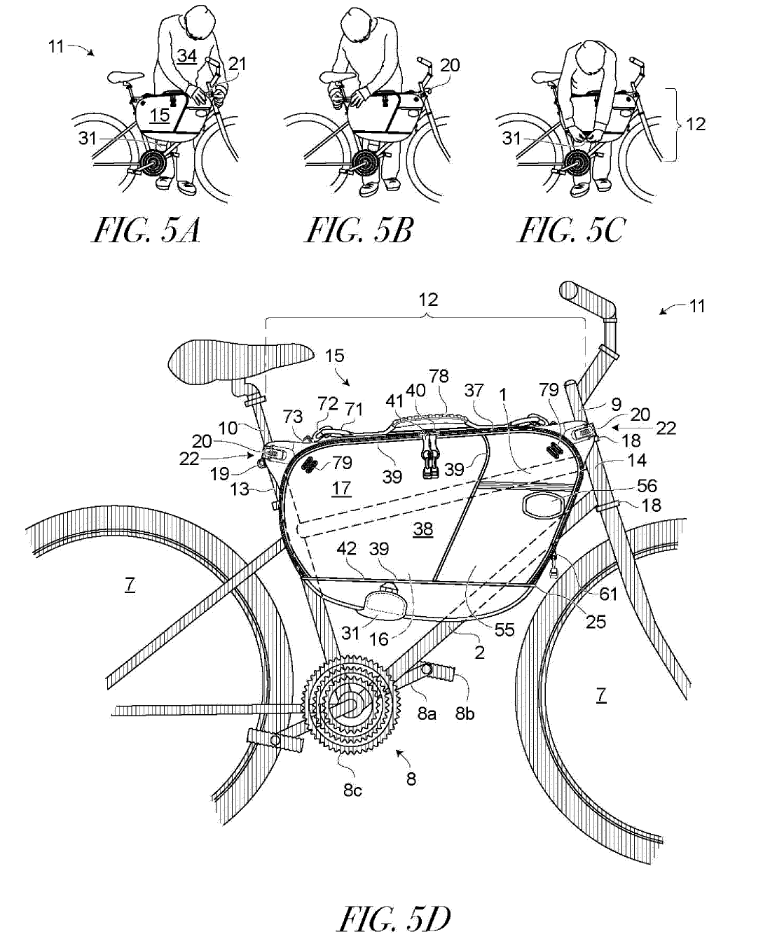

With reference to FIGS. 3A-C, in the preferred embodiment, each of the pair of ratchet assemblies 22 follow a semicircular route around handlebar headset 18 or handlebar stem 9 at the front, and seat-post 110 at the rear. Ratchet buckle 21's connectable association with ladder strap 20 is operationally diagrammed in FIGS. 4A-E infra. Ratchet buckles like this are well-known in the art of snowboard, ski boot and snowshoe bindings and many other outdoor sports in general. Either of straps 20 may alternatively wrap around a supporting structure and attach to buckle 21, located on the same saddlebag 16 or 17. Straps 20 may also wrap around a supporting structure and feed through another saddlebag 16 or 17 before attaching to buckle 21.

With reference to FIG. 3C, in cases where bicycle 11 may not be equipped with a suitably protruding headset 18 of FIG. 3B or seat-post clamp 19 of FIG. 3A, ladder strap 20 may be fitted with a self-adhesive molded rubber or plastic bumper 24, which users may adhere as necessary without specialized knowledge, skill or tools to provide the requisite protruding ledge upon which ladder strap 20 may ride.

with reference to FIGS. 4A-E, each of ratchet assemblies 22 comprise ladder strap 20, ratchet buckle 21 and ratchet release lever 23. In the preferred embodiment, such ratchet buckles 21 offer an optimally quick and secure method of drawing together or releasing two opposable parts and are easy to operate even with gloved hands. In this way, a rider may, with minimal effort or nuisance, securely attach article carrier 15 to a parked bicycle 11 and commence riding. Article carrier 15 is thus securely and firmly yet shock-absorbingly attached to the bicycle 11 in three elegantly simple and fluid operations—specifically, attachment and tightening of a pair of ratchet assemblies 22 and attachment of bottom elastic tether (not shown)—representing a unique improvement over prior art. Likewise, detachment operations are equally simple and fluid. Many such ratchet buckle types are available off the shelf, but the type depicted in the present preferred embodiment offers an enhanced release mechanism as demonstrated in FIGS. 4D-E, in which the direction of the force applied to release lever 23 aids in pulling ratchet buckle 21 apart from ladder strap 20 in one elegantly simple and fluid movement. In this way, a rider, upon reaching a destination, may park a bicycle 11, and, in a short series of simple, fluid motions, detach an article carrier 15 from a bicycle 11 and be on their way with optimally minimal effort. Moreover, these attachment operations may be made to a variety of frame types, such as those depicted in FIGS. 1A-D and FIG. 2, representing a further unique improvement over prior art.

With reference to FIGS. 5A-C, these attachment operations require relatively comfortable ergonomic postures for the user 34 relative to a bicycle 11, representing yet another improvement over prior art. Ladder straps 20, ratchet buckles 21 and tether 31 can be attached to bicycle 11 without the use of frame 12. In this or any alternate embodiment, these operations could be performed in any order desired by the user 34.

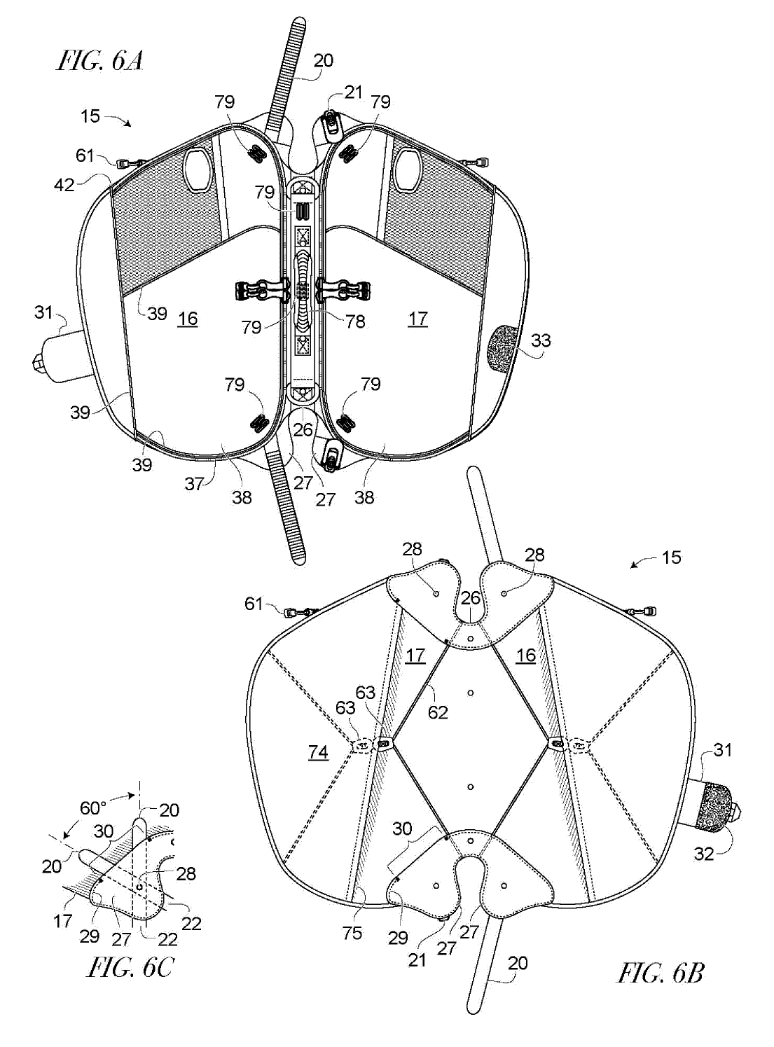

With reference to FIGS. 6A and 6B, in the preferred embodiment, article carrier 15 is composed of a left saddlebag 16, a corresponding mirror-image right saddlebag 17 and an associated center spine 26 common to both. In this embodiment, the article carrier's outer surfaces may be of any suitable commercially available fabric such as denim, leather, canvas, mesh, ripstop, synthetic fabric or the like which is typically used in construction of backpacks, bicycle packs or soft-sided luggage. In an alternate embodiment, article carrier 15 may comprise asymmetrically-shaped saddlebags 16, 17. In yet another alternate embodiment, article carrier 15 may comprise very little to no central spine 26. Each saddlebag 16, 17 comprises at least one pocket for holding any of a variety of articles. The pockets may be sealed by snaps, zippers or other fastening mechanisms or techniques known in the art or alternatively may simply be left open.

Still referring to FIGS. 6A and 6B, in the preferred embodiment, ladder straps 20 are each pivotally attached to left saddlebag 16's front and rear corner attachment flaps 27 by means of a single rivet 28, thus allowing an adjustable angle by which ladder straps 20 may wrap around their respective handlebar stem 9 (not shown) or seat-post 10 (not shown), as previously detailed in FIG. 3B-C, accounting for various bicycle frame geometric angularities as generalized in FIGS. 1A-D and FIG. 2. Likewise, corresponding ratchet buckles 21 each pivotally attach to corresponding right saddlebag 17's front and rear attachment flaps 27 by a similarly pivotable rivet 28, allowing a corresponding angle to which ratchet buckles 21 may accept ladder straps 20 for a secure and adaptable attachment of article carrier 15 to bicycle 11 (not shown). In an alternate embodiment, straps 20 and buckles 21 may be reversed or located in a different location on article carrier 15. Corner attachment flaps 27 of article carrier 15 will likely extend beyond the main pack so that a cutout in carrier 15 can easily slip vertically over any bicycle seat. The flaps 27 provide the additional benefits of protecting parts of a frame 12's (not shown) surface from abrasion, and distribute the buckling tension radially across a larger surface of article carrier 15 than conventional bike bags.

Again with reference to FIGS. 6A and 6B, a bottom tether 31 is affixed to and projects downward from the lower portion of left saddle bag 16, generally in the area, with reference to FIG. 2, above the intersection of the bicycle frame 12 and crankset 8, to whose terminating underside end is sewn loop-patch 32 of a hook and loop fastening means, for example comprising a material generically known in the art by the brand name Velcro®. Correspondingly on article carrier 15's right saddlebag 17, generally in the area above the intersection of the bicycle frame 12 (not shown) and crankset 8 (not shown), hook-patch 33 is sewn or connected. In an alternate embodiment, tether 31 may be located elsewhere on carrier 15 and attached by similar methods known in the art.

With reference to FIG. 6C, terminal ends of ladder straps 20, after having passed through ratchet buckles 21 (not shown), may extend beyond the confines of stitching 29 of corner attachment flaps 27 to right saddlebag 17 by means of passthrough slit 30 created by a gap in stitching 29 represented by small solid black squares of said flap 27 to said saddlebag 17, such that ratchet assembly 22 may pivot roughly 60 degrees, enough to account for extremes associated with variations of frame geometries as suggested by FIGS. 1A-D and FIG. 2.

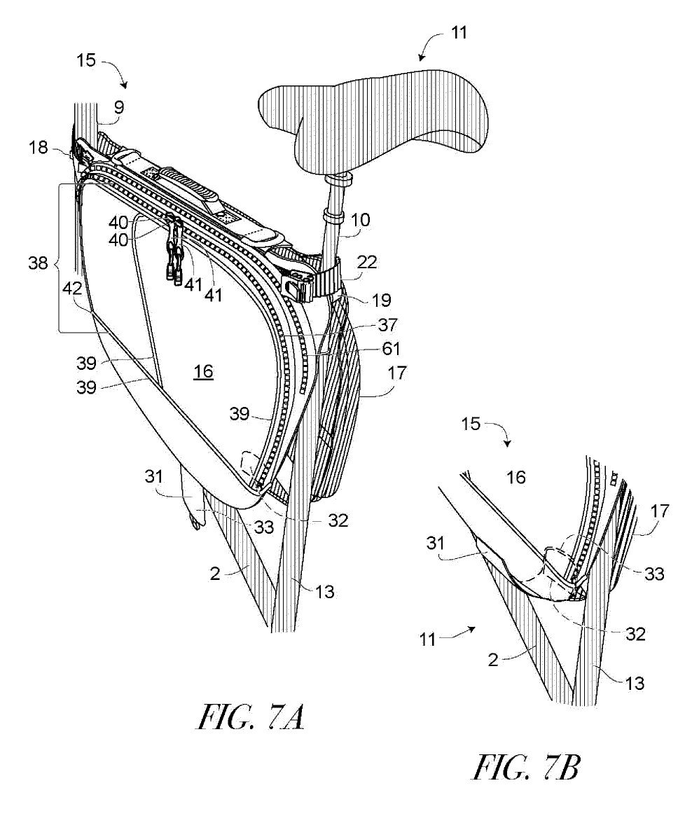

With reference to FIGS. 7A and 7B, the purpose of tether 31 will make itself apparent. FIG. 7A shows tether 31 in its unfastened mode, with saddlebags 16 and 17 hanging freely by force of gravity alone. FIG. 7B shows in detail view tether 31 in its fastened mode, with saddlebags 16 and 17 drawn together and separably connected by means of bottom elastic tether 31's associated corresponding unseen hook and loop patches 33 and 32, respectively, such that saddlebags 16 and 17 become tethered to each other and embrace intervening bicycle frame members 2 and 13, rendering article carrier 15's saddlebags 16 and 17 unable to swing freely by force of gravity or by centrifugal force caused by the cornering or other dynamics associated with normal usage of the bicycle.

In the preferred embodiment, ratchet assemblies 22 are adjustably tightened to a degree that they alone provide secure semirigid support of article carrier 15 to bicycle 11 independent of any other bicycle frame member. Such semirigid support, while virtually infallible, may act as a shock absorbing mechanism to protect the article carrier's cargo from undue vibration caused by uneven road conditions and is therefore considered a favorably novel attribute of the utility of the disclosure, as opposed to harder mechanical fastening methodology employed in prior art which tends to transfer every shock encountered by the bicycle tires directly through the rigid frame to the load attached rigidly thereto.

FIGS. 11A-B are illustrative of a second important utility of tether 31. In simplified form, FIGS. 11A-B show cross-sectional rear-views of article carrier 15 in its unpacked and packed conditions, respectively. In FIG. 11B, a fragmentary bicycle rider's unshod right foot and unclothed ankle 35, shown from the same view, are depicted at the apex of the arc which the rider's foot follows in the path of the arc of bicycle pedal 8b. A horizontal arrow adjacent to the rider's medial malleolus 36, or the bony bump at the inside of the human ankle, indicates the minimum clearance required between a bicycle article carrier 15 and crucial anatomical feature, medial malleolus 36 of any rider's body necessary as to not cause repeated irritation to ankle 35 as it travels its path relative to pedal 8b in the act of using a bicycle 11.

As a side note, testing has shown that, while the knees of a rider may spread apart relatively widely from one another as required by the width at the upper portions of any mid-frame article carrier similar to the present, disclosure, the foot and ankle position of the rider, and thus the width of the lower portion of article carrier 15, cannot be compromised relative to the bicycle's pedals. Tests have further shown that repetitive grinding contact against an article carrier's outer surface by medial malleolus 36 in particular proved especially irritating, causing aggravated nuisance or pain through persistent and unavoidable friction with the article carrier 15. Therefore the width of article carrier 15 at and in the general vicinity of rider's medial malleolus 36 as its path follows pedal 8b's arc must be kept within a certain frame of reference, or tolerance. That tolerance is indicated in simplistic terms by the double headed arrow projecting horizontally from medial malleolus 36. Thus, another purpose for tether 31 is to limit the width of a crucial lower portion of article carrier 15 to within that tolerance such that undue physical irritation is not unavoidably caused through repeated contact with rider's medial malleolus 36 as it follows its unyielding path relative to the bicycle's pedals 8b in the normal operation of a bicycle.

2. Carrying Articles

Now that one has an article carrier attached to a bicycle 11, to what function may one put the article carrier to use? Typical practices of three hypothetical users invite consideration: (1) a student or business commuter's notebooks, pencils, textbooks, snacks and laptop computer; (2) a daily business commuter's laptop computer, business papers and lunch; (3) an errand runner's shopping purchases and wallet or purse. Many other possible users may also be suggested, such as a cycling enthusiast's athletic necessities, or a recreational user's picnic lunch, blanket, camera, sunscreen and insect repellent, or even a law enforcement officer's duty kit. For simplicity though, consider the needs of the three enumerated demographic profiles.

All three users may have additional requirements in common, such as wallet, keys, glasses, water, newspaper, baseball cap, cellular telephone, digital music player and the like. Moreover, all cyclists require integrated safety considerations in every aspect of their bicycle accessories. An article carrier for these users should be engineered with at least these usages in mind. Prior art, particularly prior-art of mid-frame article carriers, has not fulfilled this obligation in a practical sense. The present disclosure has uniquely attempted to bridge that gap and answer to these users' presumed specific requirements.

Expandability is an essential solution to these users' requirements. The present disclosure in its preferred embodiment is engineered to minimize an article carrier's bulk when extra capacity is not required, and to maximize capacity on demand, keeping within tolerances dictated by bicycling dynamics, the cyclists' ergonomics and the physical environment.

Again with reference to FIGS. 7A and 7B, article carrier 15 is shown in perspective view according to the preferred embodiment taken from the left rear of bicycle 11 to which article carrier 15 is mounted. Left and right saddlebags 16 and 17 each feature door zipper track 37 circumnavigating the upper three sides of a generally rectangular opening at whose lower terminating ends door hinge 42 pivots, creating compartment access door 38 which is stiffened around door 38's outer surface edges with a surrounding bead of rubber or soft plastic structural piping 39 to add a measure of semi-rigidity to planar compartment access door 38. In the preferred embodiment of the disclosure door zipper 37 is of a configuration commonly known in the art as a closed end two-way “O” form, in which two individually adjustable zipper sliders 40 with their associated slider pull-tabs 41 are assembled to closed end door zipper track 37 allowing for an “O”-formed opening between pair of sliders 40. This zipper configuration is commonly used in the arts of backpacks, luggage and the like. In the preferred embodiment, piping 39 is covered in a commercially available reflective material such that it may brightly reflect light at nighttime for the safety of the bicycle rider. In alternate embodiments, piping 39 may be absent.

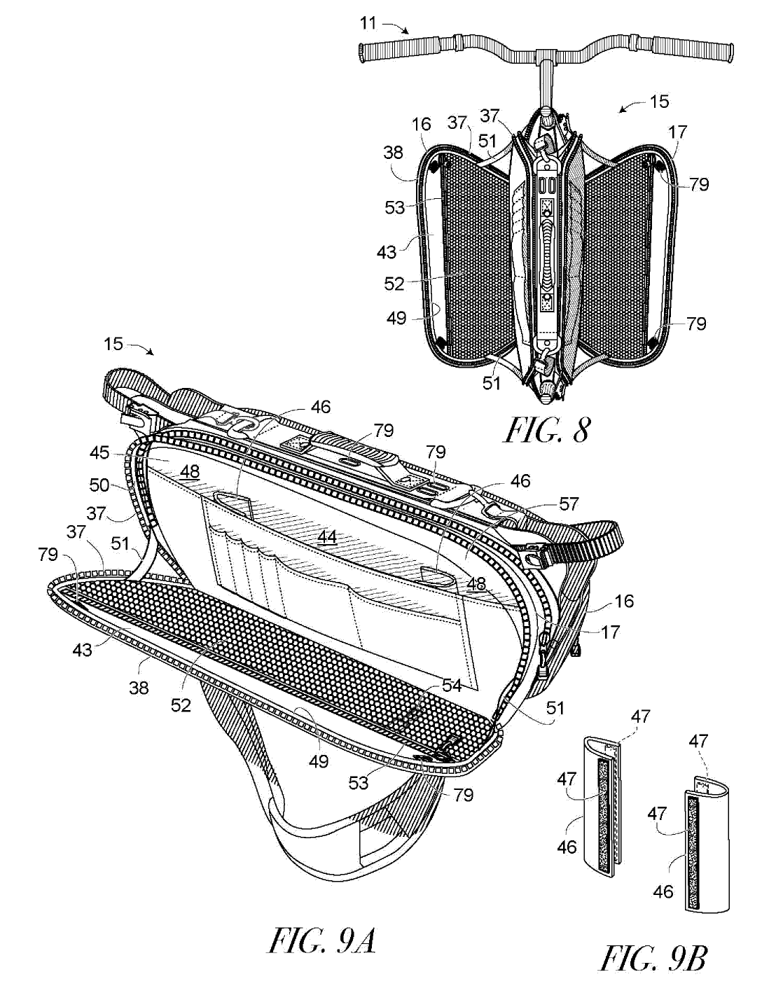

With reference to FIGS. 8 and 9A, article carrier 15's compartment access door zipper tracks 37 are completely unzipped, revealing article carrier 15's inner compartment 43, whose total capacity when taking into account saddlebags 16 and 17's corresponding capacity are each sufficiently large enough to accept articles such as a 17 inch laptop computer, a loose-leaf notebook, a textbook, a medium sized bag of groceries or a moderate combination of these articles. In alternate embodiments, carrier 15's capacity could vary to accommodate different purposes.

Sandwiched between article carrier 15's outer-fabric and inner compartment 43 lining fabric may be a thin layer of closed-cell foam padding (not shown) to serve as cushioning protection for the article carrier's cargo with the added benefits of providing waterproofing and thermal insulating characteristics inherent in such foam padding material. Besides foam padding, alternate embodiments' outer or inner fabric may comprise decorative elements such as rhinestones, patterns, lettering, logos or even licensed artwork.

With reference to FIGS. 9A and 9B, the preferred embodiment of the disclosure features an inner compartment 43 including a variety of separated pockets of various utility. One of these is designated specifically as a laptop computer pocket 44 which is lined in a commercially available lightweight microfiber fabric 45 that is nonabrasive to the delicate surfaces of electronic equipment such as laptop computers, cameras and the like. By coincidence, said microfiber lining fabric 44 has properties analogous to the softer loop side of the hook and loop closure material, such as Velcro®. Taking advantage of this serendipitous coincidence, pocket dividers 46 of a kind well-known in the art of camera bags and the like may be made of appropriately sized rectangles of padded microfiber fabric to which two strips of hook-side tape 47 are vertically sewn or otherwise adhered to either end of one rectangular side, as detailed in FIG. 9B, and folded over to create two opposing semicircular columns. Such pocket dividers 46 may be separably connectable due to the materials' mutual hook-and-loop properties inside laptop computer pocket 44 in any configuration a user may desire in order to customizably form-fit any particular laptop computer snugly within laptop computer pocket 44's inner volume. Moreover, such pocket division thus creates on either side of said pocket dividers 46 two subdivided smaller padded and microfiber-lined supplemental pockets 48 suitable to smaller delicate electronic gear such as computer peripherals, cameras, digital music players and the like.

Surrounding the inner surface edge of compartment access door 38 is inner door weatherproofing piping 49 corresponding to outer door structural piping 39 of FIG. 7A. A corresponding bead of inner opening weatherproofing piping 50 surrounds the inner lip of access door 38's opening such that, when access door 38 is zipped shut, piping 49 and piping 50 meet in parallel producing a weathertight seal behind closed door zipper track 37. Pliable fabric door retaining straps 51, which are sewn or otherwise affixed inside both separable halves of door zipper track 37 at corresponding points somewhat higher than door zipper track 37's terminating closed ends toward the lower corners of opened compartment access door 38, restrain door 38 from opening more than approximately 45°, forming a basket-shaped container within the opened compartment 43's volume thus helping keep cargo within from possibly falling out. Retaining straps 51 also aid the user in zipping the opened door 38 closed again in a convenient one-handed operation by restraining the access door against the force of gravity to an angle acute enough that a one-handed zipping operation is possible. In a downscale embodiment of carrier 15, piping 49, 50 may be absent.

Sewn or otherwise adhered to the inner surface of compartment access door 38 is inner door mesh pocket 52 whose outer profile conforms to the general shape of access door 38 and whose upper opening is positioned somewhat lower than access door 38's upper perimeter. Inner door mesh pocket zipper 53 is sewn or otherwise adhered to this upper opening of the generally rectangular shape of inner mesh pocket 52. In the preferred embodiment, inner mesh pocket 52 thus provides a convenient place for the user to store small valuables such as money and the like, such that these valuables are distinctly and securely segregated from other articles and thus won't become lost or inaccessible, and yet are identifiably visible through pocket 52's mesh fabric. Moreover, in the preferred embodiment, a small pliable strap is sewn inside pocket 52 to which small utility swivel hook 54 is affixed, providing the further convenience for the user that smaller valuables such as keys may be securely and separably affixed such that they too won't become lost or inaccessible, yet are identifiably visible through pocket 52's mesh fabric. In an alternate embodiment of carrier 15, various pockets 44, 48, 52, 53, 55 (not shown) and swivel hook 54 may be of almost any size or completely absent.

Countless other possible embodiments may include an infinite variety of further auxiliary inner and outer pockets which may further convenience the user, but are deliberately not shown in the drawings for the sake of clarity. Especially noteworthy though, and therefore included in FIGS. 2 and 5D, outer elasticized mesh pockets 55 provide convenient access to certain discretionary articles deemed useful by the user while riding or carrying, such as a water bottle, snack, map, cellular telephone and digital music player. In the preferred embodiment, a molded rubber or pliable plastic branding patch 56 is sewn or otherwise affixed to outer mesh pocket 55, providing at least two subtle yet useful utilities: to provide the user an obvious visual cue to discern article carrier 15's forward and rearward ends; and to provide an extra modicum of grip to items such as water bottles stored in outer mesh pocket 55. In alternate embodiments, branding patch 56 could be made of other suitable materials and be located on or attached virtually anywhere to article carrier 15.

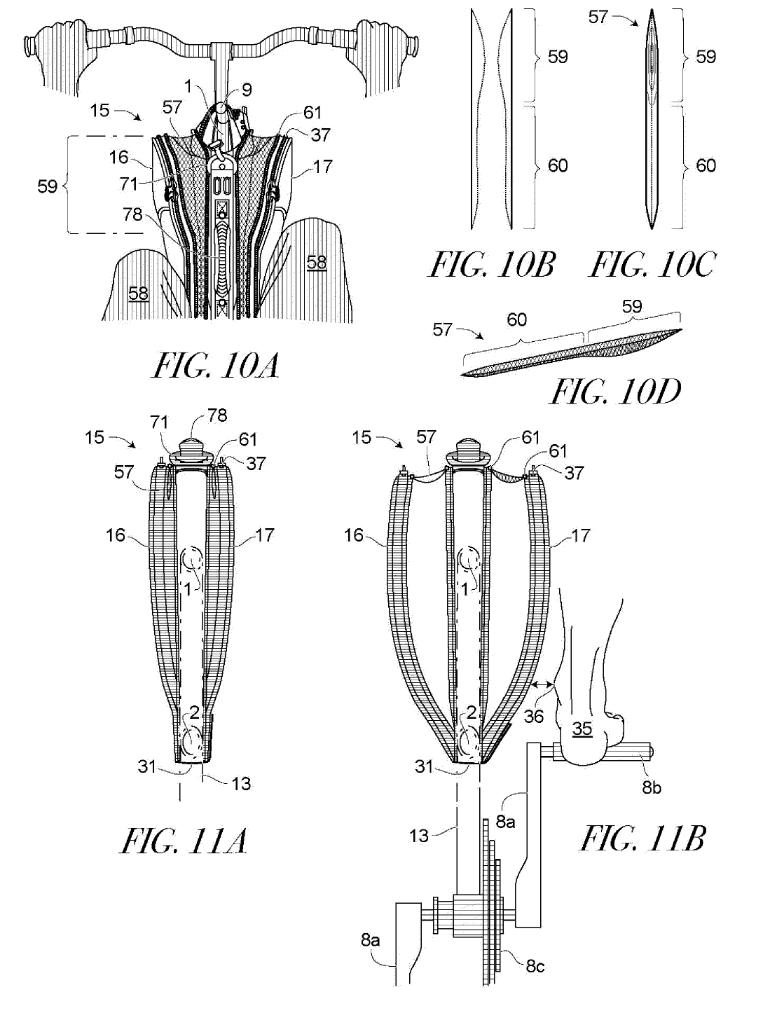

With reference to FIGS. 10A-D and 11A-B, in the preferred embodiment, pleated expansion gussets 57, of a kind well-known in the art of expandable luggage, are incorporated into the side and top walls of saddlebags 16 and 17. Expansion gussets 57 allow for significant volumetric expansion of saddlebags 16 and 17s' compartments when placed under circumstantial demand due to load conditions. As previously discussed with reference to bottom tether 31, testing has shown that while the knees of a rider may spread apart relatively widely from one another as required by the width at the upper portions of any mid-frame article carrier, the foot and ankle 35 position of the rider, and thus the width of the lower portion of the article carrier 15, cannot be compromised relative to a bicycle's pedals. When deployed expansion gussets 57 thus allow for considerable expansion at the upper portions of saddlebags 16 and 17s' widths and taper saddlebags 16 and 17s' widths to a tolerable dimension toward the lower portions of their widths. Therefore, with reference to FIGS. 10A-D, expansion gussets 57 are wider at the front than the rear such that their forward portions 59, where saddlebags 16 and 17s' widths are least affected by rider ergonomics—that is, forward of the rider's knees and upper legs 58—may expand considerably more than their rearward portions 60, where saddlebags 16 and 17s' widths are minimized to avoid unergonomic impact with the rider's knees and upper legs. In an alternate embodiment of carrier 15, expansion gussets 57 may be spring loaded or electromechanically controlled. In yet another embodiment, expansion gussets 57 may be completely absent.

As a side note, a certain degree of incidental contact between article carrier 15 and rider's knees and upper legs 58 as seen in FIG. 10A is unavoidable, but of minimal negative impact on the rider's comfort and performance. Furthermore, in the preferred embodiment of the disclosure, the use of a smooth, glossy fabric of a satin-like finish in the rearward portions of saddlebags 16 and 17 effectively mitigates what little negative impact there may be on rider comfort and performance by reducing unnecessary friction to a minimum.

When circumstances permit, expansion gussets 57 may be minimized by means of a second set of external expansion gusset zippers 61 located parallel to and sewn or otherwise affixed directly to the outer perimeters of the set of door zipper tracks 37 such that, when expansion gusset zipper 61 is slidably closed, expansion gusset 57 is folded within and therefore captured and not allowed to expand. In the preferred embodiment, expansion gusset zippers 61 are of the type known in the art as a one-way closed end zipper such that the opening begins toward article carrier 15's forward termination 59, where the user's ergonomics more easily allow for a wider expansion of saddlebags 16 and 17, and end at a closed ended zipper toward saddlebags 16 and 17's rearward portion 60, when circumstances dictate that maximum expansion is necessary. In this way, the degree of expansion may be adjusted at the user's discretion by the length the user wishes to open gusset zipper 61.

With reference to FIGS. 10A-D, aforementioned “wider-at-front” and “narrower-at-rear” shape, is, achieved in the preferred embodiment by sewing two mirror-image curved shapes of suitable lightweight pliable fabric together along their curved sides, as seen in FIG. 10B, resulting in a “boat-shaped” configuration where the bottom profile of the “boat” is deeper at the front, as seen in FIG. 10D, and top edges of the “boat” are both of equal length and parallel to each other, as seen in FIG. 10C, such that expansion gusset zipper 61 may be suitably incorporated. Expansion gusset 57 is thus pleated and naturally tends to fold away from expansion gusset zipper 61 to avoid entanglement when gusset 57 is captured by zipper 61 in a closing operation.

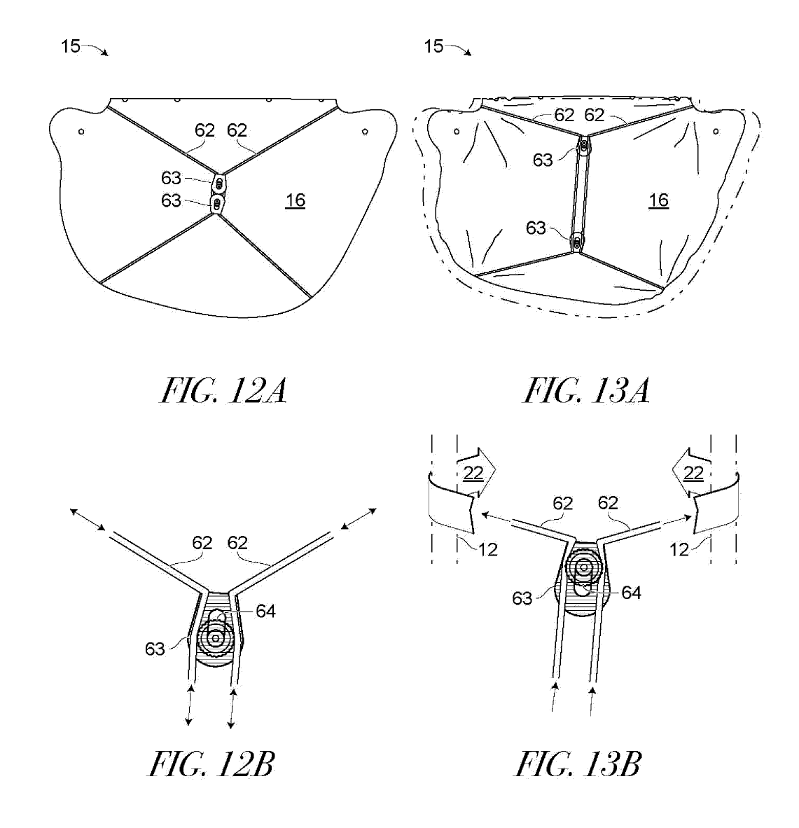

The preferred embodiment of the disclosure as explained so far makes allowances for bicycle frames of various types and styles, i.e. men's, women's, racing-style, road- or touring-style, BMX- or mountain bike-style, “California Cruiser”-style as seen in prior art of FIGS. 1A-D and variants as seen in FIG. 2, but makes only minimal allowance so far for bicycle frames of differing sizes. With reference to FIGS. 12A-B and 13A-B, the disclosure according to the preferred embodiment answers this problem by means of an adjustment mechanism.

With reference to 12A and 13A, terminal ends of a pair of lightweight pliable adjustment cords 62 are sewn or otherwise affixed to article carrier 15's underside surface at each of the four corners of the preferably rectangular saddlebags 16 or 17. Saddlebags 16, 17 may take various shapes conducive to a wide range of purposes and activities. Adjustment cords 62 are laced through a pair of diametrically opposing one-way cordlocks 63 of a kind well-known in the art of backpacking gear and the like. With reference to FIGS. 12B and 13B, these one-way cordlocks allow for their associated cords to move freely through them in either direction as represented by double-headed arrows in FIG. 12B when integrated brake wheel 64 is in its open position, but are prevented when captured, either by elective adjustment to closed position by the user or automatic adjustment to closed position through the effect of cords 62s' interactive friction upon the clogged points of brake wheel 64, from movement in the outward and upward direction as represented in FIG. 13B by outwardly and upwardly pointing arrows.

Configured as such, with reference to FIG. 12A, when the set of two opposing one-way cordlocks 63 are slidably moved to positions nearest each other, the untensioned terminal ends of adjustment cords 62 have no effect on article carrier 15's four corners to which said terminal ends are affixed; however, with reference to FIG. 13A, when the set of two opposing one-way cordlocks 63 are slidably moved apart from each other, the effective lengths of adjustment cords 62 are shortened, thus tensioning the pliable nature of article carrier 15 such that the four corners to which adjustment cords 62 are affixed move closer to the center. This tensioning adjustably diminishes the outer dimensions of saddlebags 16's profile, as represented by the difference between phantom unadjusted saddlebag 16 or 17 (not shown) and the non-phantom adjusted depiction of same, to the degree that article carrier 15 may now fit a smaller bicycle frame than it would have prior to adjustment. Some minor degree of wrinkling occurs under adjustment, which is deemed unavoidable and of minor consequence. Similar adjustment, expansion or contraction methods and devices known in the art may alternatively be employed without detracting from the novelty or utility of the present disclosure.

With reference to FIG. 13B the one-way braking characteristic of cordlocks 63 prevents inevitable disadjustment caused by tensioning in the opposite direction due to the outwardly directional tug produced by ratchet strap assemblies 22 at article carrier 15's upper corners as they tighten onto bicycle frame 12, as well as, in the case of the diametrically opposed lower cordlocks 63, the downwardly directional tug of gravity upon a heavily laden article carrier 15.

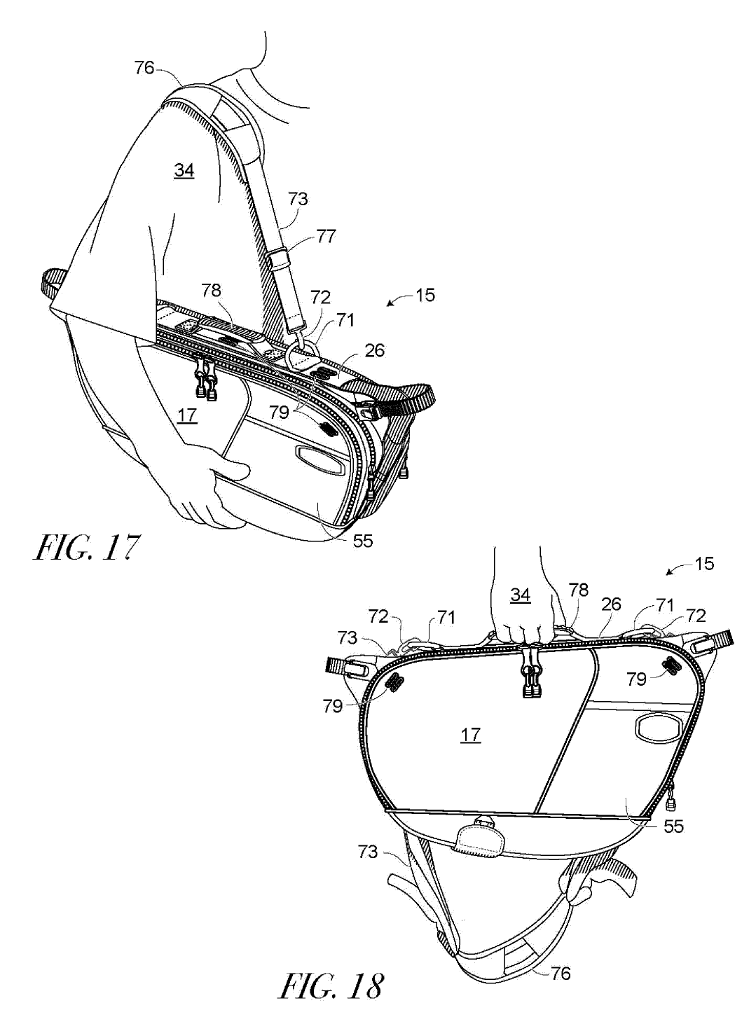

Thus, with a simple spreading apart of one-way cordlocks 63 to each of saddlebags 16 and 17, an article carrier according to the preferred embodiment may be electively adjusted by a user to suitably fit a range of bicycle frame sizes. As a side note, such adjustment need take place only occasionally. As such, adjustment cords 62 are situated as inconspicuously as possible, that inconspicuous location being, with reference to FIGS. 6B and 16, partially within the inner volumes of underside pockets 74. Such location offers an added benefit of serving as a means of retaining items stored in said underside pockets 74 at the discretion of the user simply by placing such items behind cords 62 rather than in front of them. In an alternate embodiment underside pockets 74 may be resized or absent.

3. Detachment from a Bicycle

In its preferred embodiment, the present disclosure is intended not only as an improvement over prior art of bicycle article carriers of the mid-frame variety, which have generally not gained widespread adoption in the marketplace, but also over bicycle article carriers in general, particularly front-mounted bicycle baskets and rear-mounted bicycle racks, which represent the vast; majority of bicycle article carriers in general use. One of these carriers' most important disadvantages is their virtual permanence on the bicycle. Once a user has taken the trouble to install a rack or basket, seldom is it removed due to the considerable effort and use of tools required. The user has little choice over the matter, regardless of changing circumstances.

A distinct advantage of the present disclosure in its preferred embodiment is its adaptability to being removed on a moment's notice. Again with reference to FIGS. 5A-C, detaching article carrier 15 from bicycle 11 is a simple matter of releasing tether 31 and in reference to FIGS. 4D-E, operating ratchet buckle 21's release lever 23 to pull corner attachment flap 27 and associated ratchet buckle 21 free from ladder strap 20. User 34 is then free to dissociate article carrier 15 from bicycle frame 12 and may then easily lift article carrier 15 free from bicycle 11 altogether. This represents another improvement over prior art of mid-frame article carriers in which the user must disassemble many more attachment points in many awkward bodily postures.

4. Additional Features

The present disclosure is intended as a practical means of conveying a variety of articles from one location to another while riding a bicycle, and as a practical means of managing these articles after arriving at a destination. Returning to the three previously proposed demographic profiles of intended users, now that a college student, daily business commuter or errand runner has arrived at school, work or shop respectively, how is one to manage one's articles while on foot at such destinations? To resolve this dilemma the article carrier offers three viable alternatives: (1) leave article carrier 15 and its cargo attached and securely locked to the bicycle 11, or detach it from the bicycle 11 and carry it comfortably (2) over one's shoulder or (3) by one's hand.

With reference to FIG. 14A, article carrier 15 is viewed from above firmly attached to fragmentary bicycle 11 by means of ratchet assemblies 22. A standard commercially available bicycle locking cable 65 is seen encircling article carrier 15. Unseen in the drawing but assumed according to normal usage, locking cable 65 passes through bicycle 11's frame in a manner in which cable 65 is inescapably linked to bicycle 11's frame. Cable 65 circuitously passes through metallic eyebolt and locking post assembly 66, which is assumed irremovably fixed to the earth, as a merely illustrative example of a typical locking station one may find at typical bicycling destinations. Cable 65 is irremovably linked to a typical commercially available bicycle combination padlock 67, shackle 68 of which passes through large zipper pull-tab holes 69 in each of two pair of zipper pull-tabs 41 associated with article carrier 15's compartment door zipper tracks 37. FIG. 14B shows in close range detail pull-tab holes 69 aligned in such a way as to accept fragmentary shackle 68 of padlock 67. In its preferred embodiment, zipper pull-tabs 41 are substantially longer than those commonly available such that their operational length 70 from linkage to slider 40 to center of pull-tab hole 69 is somewhat more than half of the distance from left door-zipper track 37 to right door zipper track 37, thus conveniencing the user while shackling pull-tabs 41 together as described supra. With reference again to FIG. 14A, once shackle 68 is linked through both pair of zipper pull-tabs 41 and padlock 67 is securely locked, article carrier 15's access door zipper tracks 37 are thus rendered incapable of being opened and in turn the contents therein inaccessible by anyone not in possession of a secret combination or other means of unlocking padlock 67. Moreover, article carrier 15 is thus irremovably secured to bicycle 11, which is in turn irremovably secured to eyebolt and locking post assembly 66 as illustrated in this example. Zipper pull-tabs 41 featuring large shackle-ready holes 69 are typically found on luggage for the same purpose as described here. While this means of security may well act as a deterrent against casual theft, it is not impenetrable to a more determined criminal armed with a simple pocketknife. In a possible high-security embodiment of the disclosure, a lightweight and slash-proof steel mesh of substantial impenetrability could be sandwiched between the article carrier's outer fabric and its inner lining, as is known to be employed in certain commercially available high security laptop computer bags. Such a possible embodiment could also comprise a slash-proof ratchet ladder strap 20 with similarly integrated steel cabling. In an alternate embodiment, accessories such as pull-tabs 41, cable 65, padlock 67 or shackle 68 may be absent or replaced by similar devices known in the art.

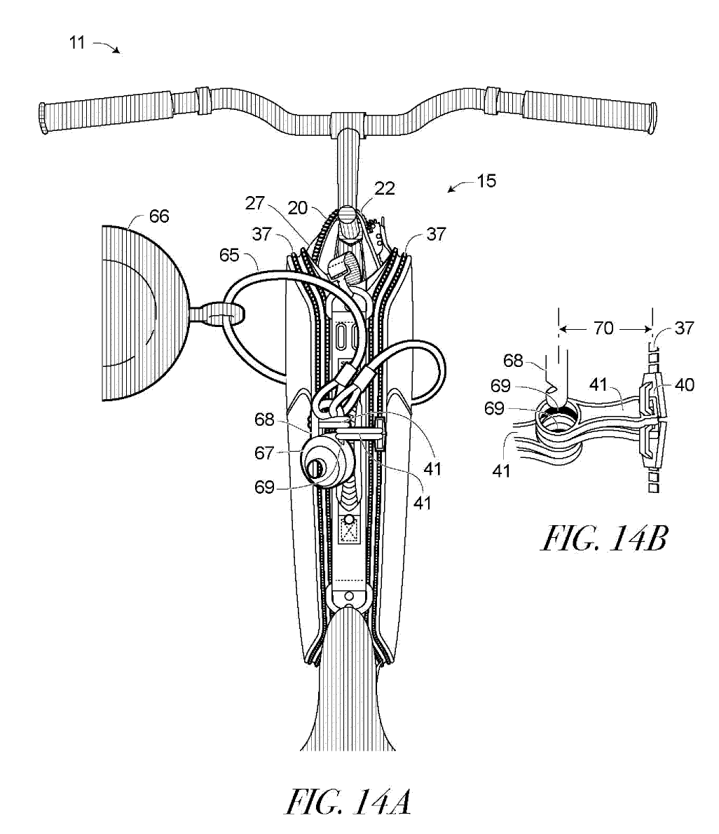

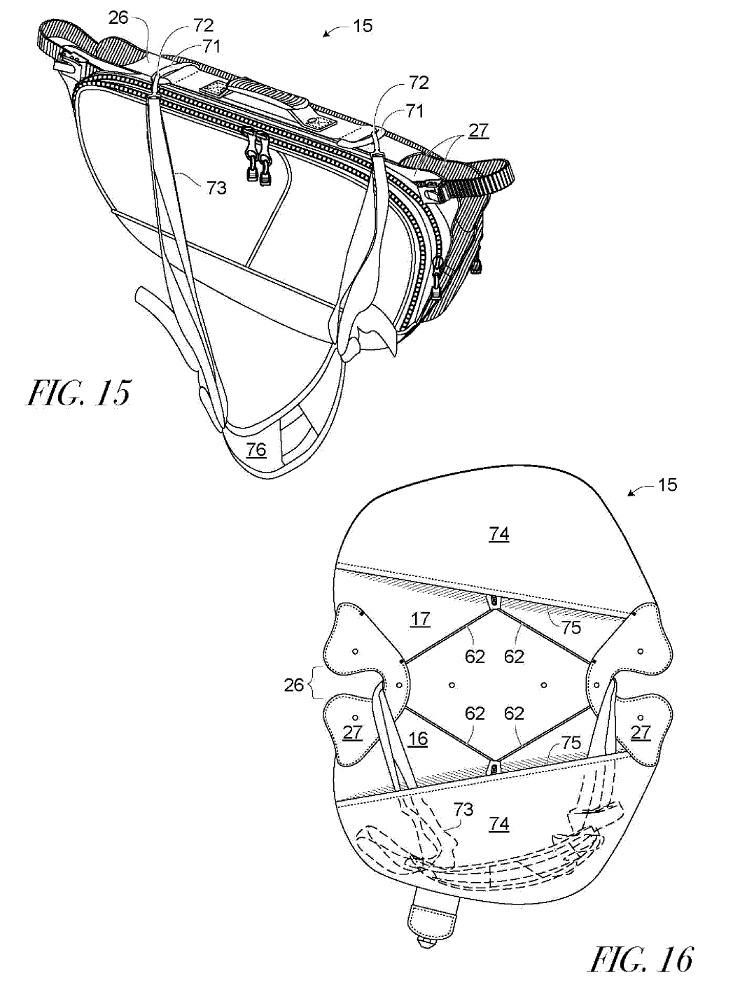

With reference to FIG. 15, article carrier 15's center spine 26 is equipped with two integrated D-rings 71 to which are attached, by means of swivel hooks 72 in a manner well known in the art, a shoulder strap 73 of pliable belt webbing of a kind well-known in the art, which comes into play should the user wish to detach article carrier 15 from a bicycle and carry it bodily along with its cargo disassociated from a bicycle. In alternate embodiments, D-ring 71 or shoulder strap 73 may be absent or attached at various other locations on article carrier 15.

With reference to FIG. 16, article carrier 15's left saddlebag 16's and right saddlebag 17's undersides are each equipped with an auxiliary underside pocket 74, whose primary intended function is for storage of shoulder strap 73 while not in use. Underside pockets 74 are each composed of a single layer of pliable fabric following the lower profile of article carrier 15's underside. A straight-line opening 75 sloping from a high point generally near the lower extremity of forward attachment flap 27 to a low point generally halfway up the rearward saddlebag wall defines the upper profile of underside pocket 74. The diagonal slant of opening 75 provides favorable ergonomic accessibility from the rear of article carrier 15, much like a slanted pants pocket provides better accessibility than an unslanted pocket, to employ an analogy any pants- wearer would be able to appreciate. Additional unintended, yet endorsed, uses for underside pockets 74 might include auxiliary storage for jackets, sweaters, umbrellas, skateboards, baseball bats, reading material or any number of other discretionary purposes a user may require.

With reference to FIG. 17, fragmentary user 34 is shown in perspective view from the right front bearing an article carrier 15 in an over-the-shoulder fashion by its pivotally attached shoulder strap 73 according to the preferred embodiment disclosure. A cushioned ergonomic shoulder pad 76, like those well-known in the art is shown which is slidably laced onto strap 73's webbing. Adjustment mechanisms 77 well-known in the art may be situated on both sides of shoulder pad 76 such that user 34 may comfortably adjust strap length from very short to very long, accommodating users of a wide range of sizes.

At the discretion of the user, a second contrivance is included for carrying article carrier 15 according to the preferred embodiment of the present disclosure. In reference to FIG. 18, carry handle 78, made of similar pliable strap webbing as shoulder strap 73 along with molded rubber or plastic ergonomic grip as is commonly used in the art, is stitched, riveted or otherwise affixed to center spine 26,, whose positioning is generally centered longitudinally as to place handle 78 at article carrier 15's center of gravity. Carry handle 78 may also serve the user when placing article carrier 15 into position on a bicycle in preparation of mounting article carrier 15 to a bicycle, or even to lift an attached bicycle off the ground as occasion may demand, as in carrying a bicycle up a flight of stairs or over an obstacle. In a downscale embodiment, shoulder pad 76 or handle 78 may be absent or located elsewhere on article carrier 15.

In alternate embodiments of the present disclosure, additional components such as elastic straps, Velcro straps, D-rings, pliable strap loops and the like may be added inside or outside the article carrier 15, for miscellaneous discretionary conveniences. Typically such additional components are added to other types of human borne article carriers such as backpacks and luggage for various discretionary purposes, and may prove to be equally useful added to the present disclosure but are not included here for clarity's sake.

Moreover, with reference to FIGS. 2, 5D, 6A, 8, 9A, 17 and 18 among others, in the preferred embodiment of the present disclosure, oblong metallic or hard plastic passthrough grommets 79 of a type well-known in the art may be added to various strategic locations of the outer surface of article carrier 15 to which a line of accessories expressly made as additionally purchasable options to the article carrier may be separably connected. Such accessory options might include bicycle lights, map pockets, GPS or digital music player compartments, or even police sirens and walkie-talkies for tactical applications. Alternatively, in upscale embodiments of the present disclosure LEDs, GPS transmitters, WiFi enabled devices, computer electronics or alarm systems may be incorporated into carrier 15.

The spirit of the present disclosure provides a breadth and scope that includes all variations of constructing the disclosed machinery and all methods of using the same. Any variation on the theme and specific embodiments of accomplishing the same that are not described herein would be considered equivalent and under the scope of the present disclosure.

What is claimed is:

1. An article carrier disposed to be attached to the handlebar headset and the seat-post of a bicycle comprising:
a pair of compartments connected at a midline;
a pair of buckles, each one of the pair of buckles located on opposite sides of one of the pair of compartments; and
a pair of straps, each one of the pair of straps located on opposite sides of the pair of compartments without the buckles.

2. The article carrier of claim 1, wherein the pair of compartments do not extend as far as a front wheel of the bicycle.

3. The article carrier of claim 1, wherein each of the pair of compartments comprises an inner width, the inner width decreasing as the distance from the midline increases.

4. The article carrier of claim 1, wherein the pair of compartments comprises an inner volume of at least 2400 cubic centimeters.

5. The article carrier of claim 1, wherein the pair of compartments are constructed of a durable material.

6. The article carrier of claim 1, wherein the pair of compartments are constructed of a lightweight material.

7. The article carrier of claim 1, wherein each of the pair of compartments further comprises a zippered door.

8. The article carrier of claim 1, wherein the pair of compartments further comprise a plurality of hanging corner sections.

9. The article carrier of claim 8, wherein the buckles and the straps are secured to the corner sections.

10. The article carrier of claim 1, wherein the buckles are self locking, the straps are notched and the buckles further comprise a quick release lever.

11. The article carrier of claim 1, further comprising at least one expansion gusset located within each of the compartments.

12. The article carrier of claim 11, wherein the at least one expansion gusset expands more toward the handlebar headset than the seat-post.

13. The article carrier of claim 1, further comprising at least one tether, the at least one tether secured to the bottom of one of the pair of compartments.

14. The article carrier of claim 1, further comprising at least one adjustment cord.

15. The article carrier of claim 1, further comprising a reflective surface or reflective detail.

16. The article carrier of claim 1, further comprising a handle.

17. The article carrier of claim 1, further comprising a shoulder strap.

18. The article carrier of claim 1, further comprising a locking mechanism.

19. A method of using the article carrier of claim 1, comprising the steps of:
placing the midline over a bicycle frame between the handlebar headset and the seat-post;
attaching one of the straps on one of the compartments around the headset and into one of the buckles;
attaching the unattached strap around the seat-post and into the unattached buckle;
fastening a tether from a lower portion of one of the compartments to a lower portion of the opposing compartment;
transporting the article carrier to a destination;
releasing the buckle holding the strap around the headset;
releasing the buckle holding the strap around the seat-post; and
unfastening the tether.

20. The method of claim 19 further comprising the step of locking the article carrier to the bicycle, carrying the article carrier by a shoulder strap or carrying the article carrier by a handle.
